(19) United States
(12) Patent Application Publication
(10) Pub. No.: US 2005/0278385 A1
(43) Pub. Date: Dec. 15, 2005

(54) Systems and methods for staggered data replication and recovery

(75) Inventors: Jesse D. Sutela, Westminster, MA (US); Mark V. Graceffa, Milford, MA (US); Wook Lee, San Diego, CA (US); David F. Huess, Hookset, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/866,385

(22) Filed: Jun. 10, 2004

(51) Int. Cl. G06F 12/00

(52) U.S. Cl. 707/200

(57) ABSTRACT

A system for replicating data is provided that includes a production replication database instance configured to communicate with a delayed replication database instance. The production replication database instance is configured on a first periodic schedule to receive updated information regarding components accessible via a network by the production replication database instance. The delayed replication database instance is configured on a second periodic schedule that is less frequent than the first periodic schedule to receive updated information regarding the components. The updated information in the delayed replication database instance can be designated to be replicated via the network to replace the updated information at the production replication database instance.

### BACKGROUND

In distributed computing environments, networked computers and other devices communicate over remote connections to accomplish tasks through client/server application programs. Distributed environments typically include a central repository of information and integrated services that provide the means to manage network users, services, devices, and additional administrative information.

Organizations operating a distributed environment need to have a way to manage network resources and services. As the organization grows, the need for a secure and centralized management system becomes more critical. A data processing system in an enterprise typically requires a large amount of data storage. One design for distributed system disperses loosely consistent copies of the data throughout the network environment that makes up the system. Customer data and data generated by users within the enterprise occupy a great portion of this data storage. Any loss or compromise of such data can be catastrophic and severely impact the success of the business.

In the type of highly distributed system which employs loosely consistent, dispersed copies of the central data, distributed resources can receive updates to any writable object that they store locally via a process referred to as “replication” in which changes are automatically copied to other systems that include a full or partial copy of the object in the network. If an error or mistake occurs that corrupts data in one system, the corrupted data may eventually be copied to all other associated replication database instances. In some circumstances, a version that was saved prior to the corruption must be recovered to replace the corrupted or missing data.

A benefit to having replicated data in a distributed network includes facilitating access to the replicated data by each of the nodes on the network. Nodes may simply obtain the desired data locally on their LAN rather than seeking the data from another node on the WAN in a perhaps more costly and time-consuming manner. In addition, replicated data helps to distribute the load on any given node that would otherwise have to maintain the data and respond to all requests for such data from all other nodes on the network. A further benefit includes enhancing system reliability, e.g., no one node (which may fail) exclusively possesses access to required data. Databases, network directory services and groupware are typical products that take advantage of replication.

Traditional recovery processes typically provide for periodic copying of critical data in the environment to a magnetic tape. The magnetic tapes may be stored on-site or at an off-site facility. In the event a recovery is required, the tapes must be located and the data is copied from the magnetic tape onto disk drives. The baseline of data that was restored is then updated with incremental backup tapes that were made throughout the course of the backup period.

Under current conditions, the traditional recovery processes are inadequate because of the amount of time required to locate the proper tapes, and, in some cases, to ship the tapes from an off-site facility, as well the time required for restoration or copying of tape data from magnetic tape onto disk. The process can take up to 48 hours, and by the time the business applications are run and resynchronized with each other, total elapsed time can be even longer.

### SUMMARY

In some embodiments, a system for replicating data is provided that includes a production replication database instance configured to communicate with a delayed replication database instance. The production replication database instance is configured on a first periodic schedule to receive updated information regarding components accessible via a network by the production replication database instance. The delayed replication database instance is configured on a second periodic schedule that is less frequent than the first periodic schedule to receive updated information regarding the components. The updated information in the delayed replication database instance can be designated to be replicated via the network to replace the updated information at the production replication database instance.

In other embodiments, a method for replicating information in a network includes configuring a production replication schedule; configuring a first delayed replication schedule with a frequency that is less than the production replication schedule; replicating information to a production replication database instance according to the production replication schedule; replicating information to a first delayed replication database instance according to the first delayed replication schedule; and designating at least a portion of the information at the first delayed replication database instance to be replicated to the production replication database instance.

In further embodiments, a computer product includes computer executable instructions operable to replicate information to a production replication database instance according to a production replication schedule, and to replicate information to a first delayed replication database instance according to a first delayed replication schedule. The first delayed replication schedule has a frequency that is less than the production replication schedule. The information at the first delayed replication database instance is replicated to the production replication database instance only when the information at the first delayed replication database instance is designated to be replicated.

These and other embodiments will be understood upon an understanding of the present disclosure by one of ordinary skill in the art to which it pertains.

### BRIEF DESCRIPTION OF THE DRAWINGS

The accompanying drawings, which are incorporated in and form a part of this specification, illustrate embodiments of the invention and, together with the description, serve to explain its principles:

FIG. 1 is a block diagram of an embodiment of a system configured with production replication database instances and delayed replication database instances;

FIG. 2 is a flow diagram of an embodiment of a process for generating and using delayed replicas of objects in the network shown in FIG. 1;

FIG. 3 shows an embodiment of objects whose implementation may include the use of delayed and production replication database instances as shown in FIG. 1; and

FIG. 4 is a block diagram of an embodiment of a replication facility suitable for use in the network shown in FIG. 1.

### DETAILED DESCRIPTION

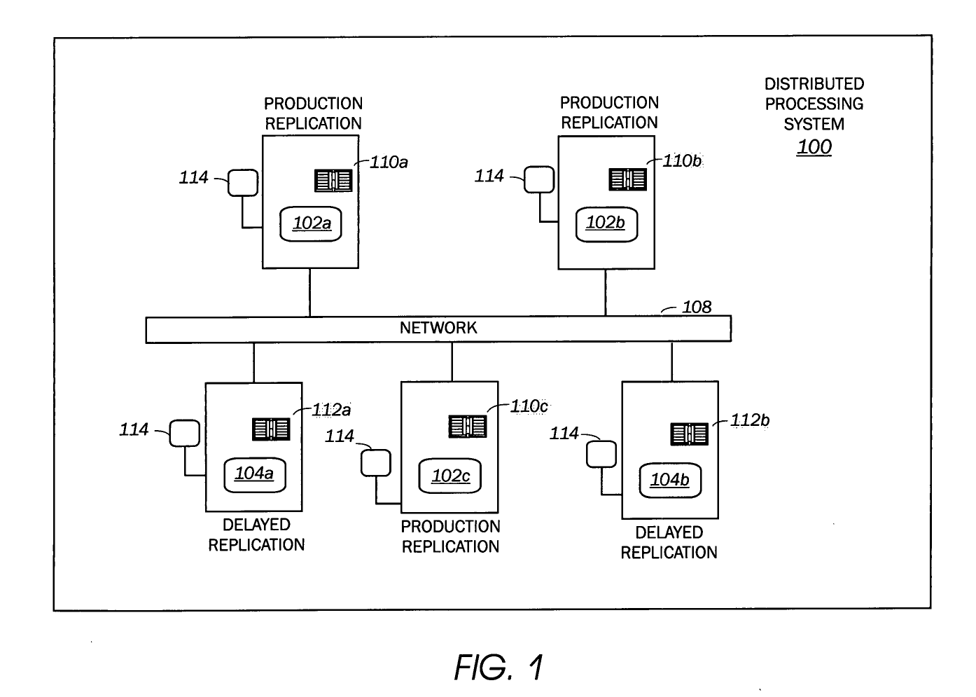

Referring to FIG. 1, an embodiment of a distributed processing system 100 allowing rapid recovery of corrupted or deleted data and objects is shown. Processing system 100 includes one or more production replication database instances 102a, 102b, 102c, and one or more delayed replication database instances 104a, 104b. Production replication database instances 102a, 102b, 102c and delayed replication database instances 104a, 104b, are sometimes referred to collectively and individually herein with the reference numerals “102” and “104”, respectively.

The system 100 can include as many production replication database instances 102 and delayed replication database instances 104 as required to support rapid recovery in the event information is deleted or corrupted and/or propagated throughout system 100 unintentionally. Database instances 102, 104 typically include a management and access interface, 114, in the form of computers and/or computer code to manage access to the database and maintain security of the resources in the respective database instance 102, 104.

Database instances 102, 104 communicate with one another via a network 108. Network 108 is capable of delivering bytes of data, e.g., messages, from one database instance 102, 104 to another. Network 108 may be a local area network (LAN), a wide area network (WAN), a telecommunication network, a computer component network (e.g., a file transfer system), a message-based network, or other suitable data transfer network system. Further, system 100 may include one or more networks 108 that are coupled together to form a single logical network system that supports appropriate communication protocol(s) (e.g., transfer control protocol/Internet protocol (TCP/IP) for the Internet). In some embodiments, components in system 100 can communicate with each other and with other external networks via suitable interface links such as any one or combination of Ti, ISDN, cable line, a wireless connection through a cellular or satellite network, or a local data transport system such as Ethernet or token ring over a local area network. Any suitable communication protocol, such as Hypertext Transfer Protocol (HTTP) and Transfer Control Protocol/internet Protocol (TCT/IP), can be utilized to communicate with other components in external networks.

Processing system 100 can include a number of resources such as the management and access interface 114, which can be embodied in any suitable processing device such as client and server processing devices. Other suitable devices can be included in system 100 such as printers, storage devices, and scanners, but are not shown in FIG. 1. Processing devices can be embodied in any suitable computing device, such as personal data assistants (PDAs), telephones with display areas, network appliances, desktop computers, laptop computers, X-window terminals, among others.

Database instances 102, 104 include a list of other production database instances 102 that should be updated when specified information changes. The changed information is propagated throughout all production database instances 102 that include a copy of the affected information according to production replication schedules 110a, 110b, and 110c which are sometimes referred to collectively and/or individually herein as production replication schedule(s) 110. For example, a production replication schedule 110 for a particular production replication database instance 102 may be set to request replication every two hours. Forty-five minutes or more may be required to replicate a change to production replication database instances 102 for a worldwide organization with a global distributed processing system 100. In contrast, the delayed replication database instances 104 typically do not request updates as frequently as production replication database instances 102. For example, respective delayed replication schedules 112a, 112b may be set to request updates once a week. Delayed replication schedules 112a, 112b are sometimes referred to collectively and/or individually herein as delayed replication schedule(s) 112.

Delayed replication database instances 104 can be configured so that changes to the replicated data are only made via the replication process and not by other resources. This ensures that the data stored at the delayed replication database instances 104 is an accurate copy of data received from the production replication database instances 102.

A system 100 can include more than one delayed replication database instance 104. The delayed replication schedule 112 for each delayed replication database instance 104 is typically staggered from other delayed replication database instances 104. For example, replication schedule 112a can allow data to replicate to the delayed replication database instance 104a every Friday evening, while replication schedule 112b can be scheduled to allow data to replicate to the delayed replication database instance 104b every Wednesday evening. If information is deleted or corrupted on one of the production replication database instances 102, the data can be recovered from the delayed replication database instances 104 with the most recent version before the data was deleted or corrupted. The recovered information can then be propagated to the other production replication database instances 102.

Replication database instances 102, 104 can also include a management and access interface 114 that allows users to access replication information in the replication database instances 102, 104. Authentication and authorization features can be included to limit access to the replication information. Other features can be implemented to allow users to access replication information across network 108 on remote replication database instances 102, 104. The management and access interface 114 can be implemented using any suitable components, such as a processing device coupled to a display device and a data input/output device.

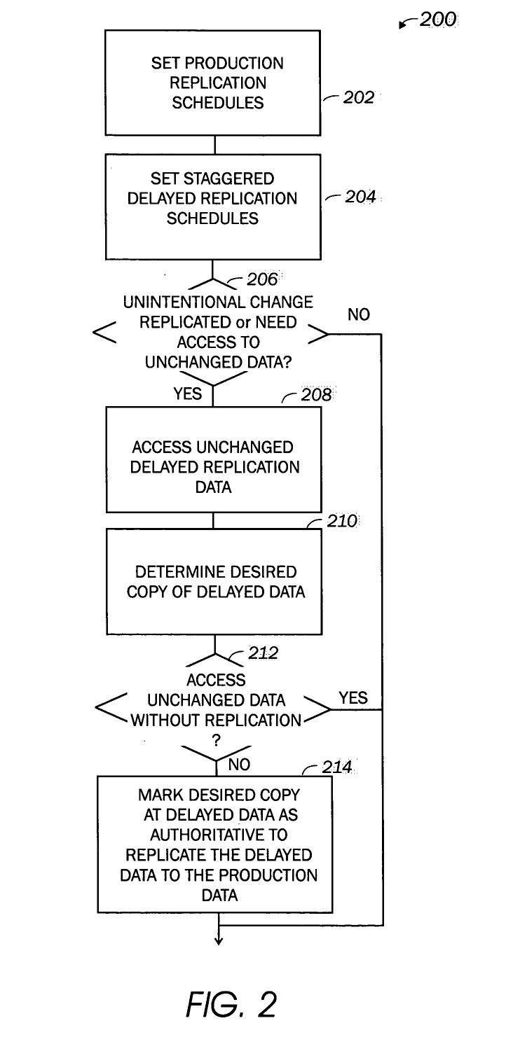

Referring to FIGS. 1 and 2, FIG. 2 shows a flow diagram 200 of an embodiment of process for creating and utilizing delayed replication database instances 104 is shown. Process 202 includes setting up the replication schedules 110 for production replication database instances 102. The production replication schedules 110 can be set to request updates at any suitable periodic interval based on a fixed amount of time and/or the number of change notices received from other production replication database instances 102.

Process 204 includes setting the replication schedules 112 for delayed replication database instances 104. Delayed replication schedules 112 are typically set to request updates at suitable staggered intervals based on a fixed amount of time or other considerations based on the behavior and requirements of the system 100. Delayed replication schedules 112 typically include more time between updates than production replication schedules 110.

The replication schedules 110, 112 can be set by administrators locally or remotely via network 108.

Process 206 includes determining whether an unintentional change was replicated across production database instances 102, or whether a user/administrator needs to access the information before the change was replicated. This portion of the process can be performed via a user interface on replication database instances 102, 104, either directly at a database instance 102, 104 or by accessing a database instance 102, 104 via the network 108. The user can view replication schedules via the interface and can access information from one or more delayed replication database instances 104 to determine the location of the desired copy of the information as part of processes 208 and 210.

Process 212 allows users to indicate whether the desired copy of the information is to be replicated across system 100. If the information is going to be replicated, then the administrator can mark the information as authoritative in process 214 via a user interface. A change notice can be sent to production replication database instances 102 to notify them that an update is available. The delayed replication database instance 104a or 104b can send a copy of the desired information to production replication database instances 102 automatically. Another alternative to sending the information to production replication database instances 102 automatically in process 214 includes allowing the production replication database instances 102 to request the update from the delayed replication database instances 104. Other suitable methods for replacing information in production replication database instances 102 can be utilized.

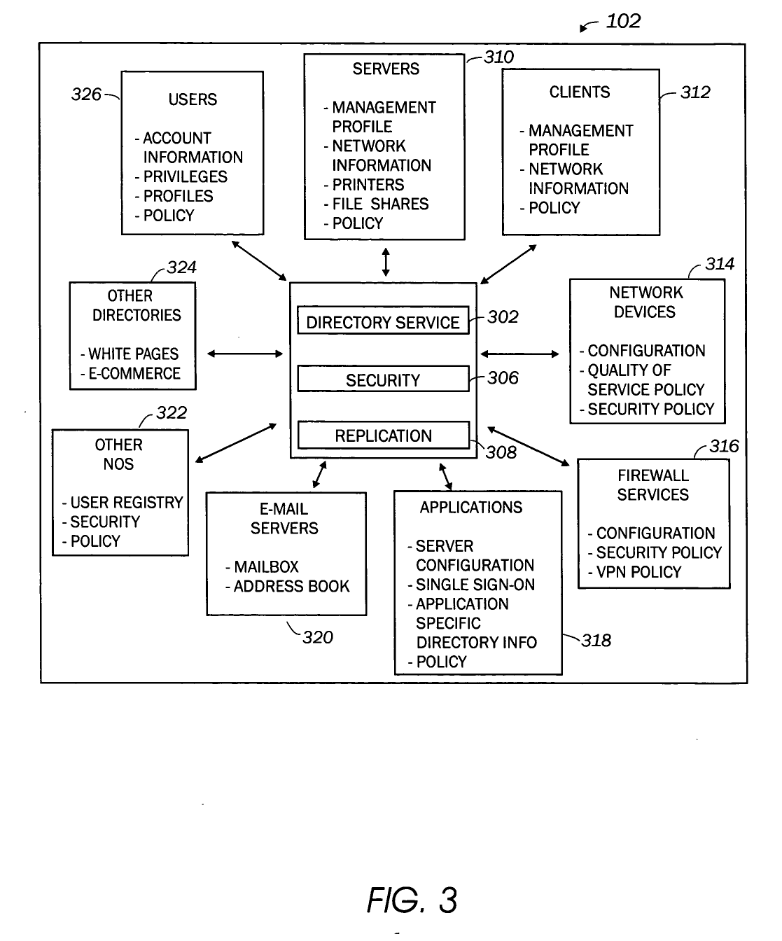

Referring to FIG. 3, an embodiment of objects whose implementation may include the use of production replication database instance 102 is shown. An object is a logical structure that includes data structures for holding data and may include functions that operate on the data held in the data structures. An object is a useful structure for encapsulating file data and file behavior into a single logical entity. In some embodiments, the data structures of objects hold properties or property sets. Objects can be added and/or deleted from replication database instances 102, 104, as required.

Replication database instances 102, 104 can be viewed as a single entity for purposes of administration, naming, and security. Each replication database instance 102, 104 can implement its own administrative and access policies. The encapsulation of objects allows replication database instances 102, 104 to act autonomously relative to other replication database instances 102, 104.

Although objects are provided as examples of resources in system 100, those skilled in the art will appreciate that the embodiments disclosed herein not limited to an object-oriented environment; rather, various embodiments may also be practiced in non-object-oriented environments. Some embodiments can be more generalized to support the replication of logical structures, such as files or file directories, in addition to, or instead of, objects.

Functions that are external to the system 100 may access the production replication database instances 102 via the management and access interface 114. Such functions can include and/or access objects that pertain to components such as directory service 302; security logic 306; replication facility 308; server computers 310; client computers 312; network devices 314 such as printers and storage devices; firewall services 316; application programs 318; e-mail servers 320; one or more network operating systems (NOS) 322; directories 324, such as telephone and e-commerce directories; and user information 326. The objects in system 100 can include information such as management profiles, network information, policies, file sharing, device and network configuration, quality of service, security, login, mailbox, email addresses, account information, privileges, and profiles. Objects representing other resources or collections of information can also be included in addition to, or instead of, the examples of objects provided herein.

Directory service entries 302 can be included in a database instance 102, 104 to provide a centralized location to store information regarding the objects in the corresponding replication database instance 102, 104. The directory service entries 302 can describe the structure of system 100, for example, directory service entries 302 can specify where a group of objects are stored. The directory service entries 302 are typically stored at well-known locations within respective database instances 102, 104 of the system 100 so that users and programs can access the directory service entries 302.

Information regarding the objects in the system 100 can be obtained by browsing or querying the global catalog 304 and/or the directory service entries 302. In addition, because the directory service entries 302 are encapsulated into objects, standardized application program interfaces (APIs) may be utilized to manipulate these objects.

Replication facility 308 supports consistent replication of objects in the system 100. The replication facility 308 may replicate single objects or may replicate logical structures that include multiple objects. The replication facility 308 reconciles local copies of objects with remote copies of objects in other replication database instances 102, 104. In some embodiments, reconciliation occurs on a pair-wise basis such that each object in a local set of objects is reconciled with its corresponding object in the remote set of local objects. Reconciliation refers to reconciling an object with a changed object so that the object reflects the changes made to the changed object. For instance, a remote copy of an object may have changed but a local copy of the object has not yet been updated to reflect the changes. An example of a commercially available replication facility 308 that can be utilized in the system 100 is the ACTIVE DIRECTORY® service from Microsoft Corporation in Redmond, Wash. Other suitable replication facilities can be used. The following example outlines the process for creating and using delayed replication database instances 104 with the ACTIVE DIRECTORY® service.

When implementing delayed replication database instances 104 using the ACTIVE DIRECTORY® service, application partitions can be included in delayed replication database instance 104. The ACTIVE DIRECTORY® service includes the ntdsutil.exe utility that can be used to add a naming context to the data to be replicated, also referred to as the replication scope, of the delayed replication database instance 104. For example, in some instances, it is desirable to restore critical data, such as domain name server (DNS) data that can be used to translate numerical addresses to corresponding domain names, quickly in the event of an accidental corruption or deletion of the data. DomainDnsZones and ForestDnsZones naming contexts can be added to the replication scope for DNS data. Once the naming contexts are added to the replication scope of the delayed replication database instance 104, the DNS data will replicate on the same delayed schedule as the other replication data.

The ACTIVE DIRECTORY® service includes one or more domains, each with one or more domain controllers (DC). Multiple domains can be combined into a domain tree and multiple domain trees can be combined into a forest. To create replication sites 104, appropriate subnets can be added to the directory configuration, and associated with sites to allow each domain controller to join the system 100 in the desired site when promoted to domain controller status. For example, single 32 bit subnets (one node) for each server's address can be created before promoting the domain controllers.

To prevent user authentication and directory lookups of stale data on the delayed replication database instance 104, a special group policy can be added to the respective delayed replication sites and therefore the associated domain controllers that host the delayed replication database instances 104. The group policy settings essentially hide the delayed replication database instance 104 from the rest of the system 100 and only allow for replication with partner replication sites. The specific policy setting for the ACTIVE DIRECTORY® service is called “DC Locator DNS Records not Registered by the DCs”, which is located under: administrative templates\system\netlogon\DC Locator DNS Records in the ACTIVE DIRECTORY® service group policy editor. The globally unique identifier (GUID) canonical name (Cname) record can be registered in DNS, along with a record for the nodename of the domain controller. The GUID Cname points to the nodename record. In one embodiment, the list of mnemonics and corresponding DNS records that are added to the policy are as follows:

| Mnemonic | DNS Record |
|---|---|
| LdapIpAddress | <DnsDomainName> |
| Ldap | _ldap._tcp.<DnsDomainName> |
| LdapAtSite | _ldap._tcp.<SiteName>._sites.<DnsDomainName> |
| Pdc | _ldap._tcp.pdc._msdcs.<DnsDomainName> |
| Gc | _ldap._tcp.gc._msdcs.<DnsForestName> |
| GcAtSite | _ldap._tcp.<SiteName>._sites.gc._msdcs.<DnsForestName> |
| DcByGuid | _ldap._tcp.<DomainGuid>.domains._msdcs. |
| | <DnsForestName> |
| GcIpAddress | _gc._msdcs.<DnsForestName> |
| DsaCname | <DsaGuid>._msdcs.<DnsForestName> |
| Kdc | _kerberos._tcp.dc._msdcs.<DnsDomainName> |
| KdcAtSite | _kerberos._tcp.dc._msdcs.<SiteName>._sites.<DnsDomainName> |
| Dc | _ldap._tcp.dc._msdcs.<DnsDomainName> |
| DcAtSite | _ldap._tcp.<SiteName>._sites.dc._msdcs.<DnsDomain |
| | Name> |
| Rfc1510Kdc | _kerberos._tcp.<DnsDomainName> |
| Rfc1510KdcAtSite | _kerberos._tcp.<SiteName>._sites.<DnsDomainName> |
| GenericGc | _gc._tcp.<DnsForestName> |
| GenericGcAtSite | _gc._tcp.<SiteName>._sites.<DnsForestName> |
| Rfc1510UdpKdc | _kerberos._udp.<DnsDomainName> |
| Rfc1510Kpwd | _kpasswd._tcp.<DnsDomainName> |
| Rfc1510UdpKpwd | _kpasswd._udp.<DnsDomainName> |

Access to the domain controllers of delayed replication database instances 104, particularly by pre-Windows2000 clients, can also be prevented by not registering the names of the domain controllers with the Microsoft Windows Internet Name Service (WINS) resolvers. The WINS resolvers allow name-to-address maps to be dynamically registered.

Additionally, Microsoft Exchange servers include a dsaccess process that uses site link cost to evaluate domain controllers binding order. The site link costs between the delayed replication database instances 104 and all other production replication database instances 102 can be set to the highest cost available to prevent access by Microsoft Exchange servers.

To recover information from a delayed replication database instance 104, the deleted object's distinguished name (DN) is provided to the ACTIVE DIRECTORY® service ntdsutil utility program to perform an authoritative restore. The DN of an object can be found by logging on to the domain controller that hosts the delayed replication database instance to be restored and using the ACTIVE DIRECTORY® service ADSIedit.msc utility program to query the domain partition for the canonical name.

Once the object is found, the domain controller containing the object to be restored can be re-booted into Directory Service Restore Mode, which allows the data to be restored as authoritative. The ntdsutil utility program is used to increase the USN (universal serial number) of the object by a large increment, such as one-hundred thousand (100,000), to ensure that the restored object wins any replication conflict. The directory database can then be replicated to the other servers.

Once the authoritative restore of the object or subtree is complete, the domain controller can be rebooted to regular mode, and the restored object can be replicated back into the rest of the system 100. Determine the production domain controller that is pulling updates from the delayed replication domain controller using the Site and Services utility. Once the production domain controller with a connection object from the desired delayed replication domain controller is found, the connection object can be selected to “replicate now” to force the production domain controller to pull updates from the delayed replication domain controller. The restored object can then be replicated back to the production domain controller.

In some instances, if a user has been deleted from an object, restoring the user will not necessarily restore all information about that user. For example, group memberships are lost in Microsoft Windows 2000 when restoring a user object. As a result, the ldifde.exe utility can be used on the delayed replication domain controller to gather member of attribute values. The member of attribute will provide information regarding the user's membership in any domain-based groups. This will be required in Windows 2000 to ensure the restored object is added to the domain groups it belonged to before deletion.

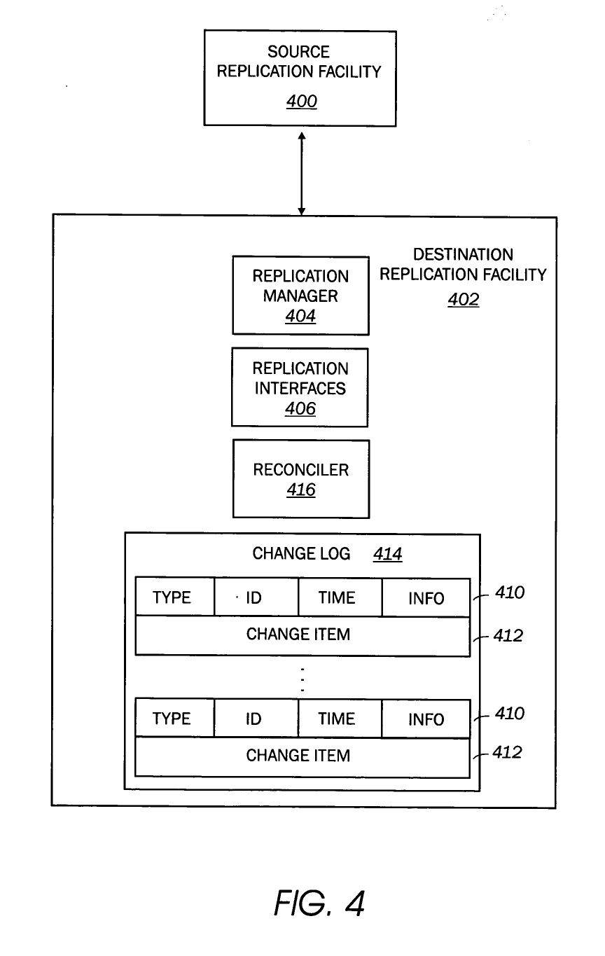

Referring to FIG. 4, a source replication facility 400 and a destination replication facility 402 are shown. Source replication facility 400 and a destination replication facility 402 can be configured as production replication database instances 102 or delayed replication database instances 104 (FIG. 1), as required. Destination replication facility 402 is shown with a replication manager 404 that loads the appropriate replication interfaces 406 according to the underlying file system and also regulates access to the replication interfaces 406. Both the replication manager 404 and the replication interfaces 406 can be provided in one or more Dynamic Link Libraries (DLLs), but may be provided in other ways, such as via drivers. Replication interfaces 406 allow access to the objects to be replicated regardless of the underlying file system.

The destination facility 402 contacts the source facility 400 and provides information via a cursor 410 indicating the point (e.g., in time or any other indicator of system activity) from which replication is desired. The source facility 400 returns changed object information, shown as change items 412, in FIG. 4, to the destination facility 402 along with an updated cursor 410 that includes information indicating the state of the source (e.g., an updated time stamp) with respect to the returned replication information. This updated replication point is stored in the cursor 410 for use during the next replication cycle. Once the change information is present locally, the destination facility 402 can store the cursors 410 and change items 412 in a change log 414, and invoke reconciler(s) 416 to update objects that have changed since the point (e.g., time) identified in the cursor 410.

Replication facilities 400, 402 can also perform incremental replication, i.e., specific changes such as create, modify, rename, delete or move operations made to an object rather than the changed object itself. The replication facilities 400, 402 may be configured to transfer the entire object when it is more efficient to transfer the object rather than the differencing information.

The individual change items 412 can either be logged as they are made to objects at the source facility 400, or dynamically rebuilt from stored information. The cursors 410 returned to the destination facility 402 can include a type field indicative of whether an object has undergone a create, modify, rename, delete or move operation, along with a serialized replication object identifier (ROBID) field that identifies which object has changed. A time stamp and other relevant information can also be included in the change log 414.

To minimize network traffic, the source facility 400 can review the change log 414 and filter out change items 412 that were originated or propagated by the requesting destination facility 402 before transmission to the destination facility 402. When the change log 414 is received from the source facility 400, the destination facility 402 can invoke reconciler 416 to apply the changes to the objects consistent with those at the source facility 400. When all change items 412 in the log 414 have been reconciled, the replication and reconciliation for that destination and source are completed.

In some embodiments, each delayed replication database instances 104 can be implemented on a dedicated server. In other embodiments, virtual server instances can be used to reduce the number of dedicated servers required to implement multiple delayed replication database instances 104.

Logic instructions can be stored on a computer readable medium, or accessed in the form of electronic signals. The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

1. A system for replicating data comprising:
a production replication database instance configured to communicate with a delayed replication database instance, wherein:
the production replication database instance is configured on a first periodic schedule to receive updated information regarding components accessible via a network by the production replication database instance;
the delayed replication database instance is configured on a second periodic schedule that is less frequent than the first periodic schedule to receive updated information regarding the components; and
the updated information in the delayed replication database instance can be designated to be replicated via the network to replace the updated information at the production replication database instance outside of the first periodic schedule.

2. The system of claim 1, further comprising:
a management and access interface configured to allow a user to view the updated information in the delayed replication database instance.

3. The system of claim 1, further comprising:
a management and access interface configured to allow a user to designate the updated information in the delayed replication database instance for replication.

4. The system of claim 1, wherein the production replication database instance is further configured to notify other replication database instances when a change has been made to information in the production replication database instance.

5. The system of claim 1, wherein the production replication database instance is further configured to receive notification from other replication database instances when a change has been made to information in the other replication database instances.

6. The system of claim 5, wherein the production replication database instance is further configured to request a copy of the updated information from another replication database instance.

7. The system of claim 1, further comprising a change log configured to indicate the type, identity, and last update time for the information.

8. The system of claim 1, further comprising a reconciler configured to change the copy of the information at the first production replication database instance to match information at a plurality of other production replication database instances.

9. A method for replicating information in a network, comprising:
configuring a production replication schedule;
configuring a first delayed replication schedule with a frequency that is less than the production replication schedule;
replicating information to a production replication database instance according to the production replication schedule;
replicating information to a first delayed replication database instance according to the first delayed replication schedule; and
designating at least a portion of the information at the first delayed replication database instance to be replicated to the production replication database instance.

10. The method of claim 9, further comprising:
configuring a second delayed replication schedule offset from the first replication schedule with a frequency that is less than the production replication schedule; and
replicating information to a second delayed replication database instance according to the second delayed replication schedule.

11. The method of claim 10, further comprising:
selecting between the information at the first and second delayed replication database instances to be replicated to the production replication database instance to replace an unintentional change in the information at the production replication database instance.

12. The method of claim 9, wherein designating at least a portion of the information at the first delayed replication database instance to be replicated to the production replication database instance is accomplished from a remote location via the network.

13. The method of claim 9, wherein the information includes objects that include data regarding at least one of: management profiles, user accounts, policies, and device configurations.

14. The method of claim 9, further comprising:
maintaining change logs in the first production replication database instance and the first delayed replication database instance, wherein the change logs are configured to indicate the type, identity, and last update time for portions of the information at each database instance.

15. The method of claim 9, further comprising:
reconciling the information at the first production replication database instance to match information at a plurality of other production replication database instance.

16. The method of claim 9, further comprising:
accessing the information at the first delayed replication database instance before it is replaced by the information at the first production replication database instance during a subsequent replication cycle.

17. The method of claim 9, further comprising:
designating the at least a portion of the information at the first delayed replication database instance to be replicated to the production replication database instance to replace an unintentional change in the information at the production replication database instance

18. A computer product, comprising:
computer executable instructions operable to:
replicate information to a production replication database instance according to a production replication schedule;
replicate information to a first delayed replication database instance according to a first delayed replication schedule, wherein the first delayed replication schedule has a frequency that is less than the production replication schedule; and
replicate the information at the first delayed replication database instance to the production replication database instance only when the information at the first delayed replication database instance is designated to be replicated.

19. The computer product of claim 18, further comprising:
computer executable instructions operable to:
reconcile the information at the production replication database instance to match information at a plurality of other production replication database instances.

20. The computer product of claim 18, further comprising:
computer executable instructions operable to:
access the information at the first delayed replication database instance before it is replaced by the information at the first production replication database instance during a subsequent replication cycle.

21. An apparatus for replicating information in a network, comprising:
means for replicating information to a first delayed replication database instance according to a first delayed replication schedule;
means for replicating information to a second delayed replication database instance according to a second delayed replication schedule; and
means for replicating the information at the first or second delayed replication database instance to a production replication database instance only when the information at the first or second delayed replication database instance is designated to be replicated by an operator.

22. The apparatus as set forth in claim 21, further comprising means for preventing a user from accessing stale data on the delayed replication database instance.

23. The apparatus as set forth in claim 22, wherein the means for preventing use of the delayed replication database instance includes a group policy added to the delayed replication database instance to hide the delayed replication database instance from unauthorized users of the network.
